(19) United States
(12) Patent Application Publication
(10) Pub. No.: US 2023/0266282 A1
(43) Pub. Date: Aug. 24, 2023

(54) VALVE SWITCHING CASSETTE FOR SELECTIVELY INTERCONNECTING COMPONENTS OF A BIOPROCESS INSTALLATION

(71) Applicant: Sartorius Stedim North America Inc., Bohemia, NY (US)

(72) Inventor: Dinesh Shukla, Bohemia, NY (US)

(21) Appl. No.: 17/675,318

(22) Filed: Feb. 18, 2022

(51) Int. Cl. G01N 30/46; B01D 15/18; G01N 30/20; B01D 15/14

(52) U.S. Cl. CPC G01N 30/468; B01D 15/1842; B01D 15/1864; G01N 30/20; B01D 15/14

(57) ABSTRACT

A valve switching cassette for selectively interconnecting components of a bioprocess installation, wherein the valve switching cassette comprises at least one fluid flow system of ports and fluid lines, which fluid flow system includes primary ports, communicating with primary fluid lines, and secondary ports, communicating with secondary fluid lines, wherein the valve switching cassette comprises an array of switchable valve units for selectively interconnecting the primary fluid lines with the secondary fluid lines via transfer fluid lines. It is prosed, that the valve switching cassette comprises a transfer plate with apertures and an elastically deformable membrane structure on each flat side of the transfer plate, that at least part of the primary fluid lines and secondary fluid lines are extending between the transfer plate and one of the membrane structures and that the transfer fluid lines are at least partly provided by the apertures.

### FIELD OF THE TECHNOLOGY

The present disclosure relates to the design of a valve switching cassette for selectively interconnecting components of a bioprocess installation, a valve switching system with such a valve switching cassette, a bioprocess installation with such a valve switching system and a method for operating such a valve switching cassette.

### BACKGROUND

The expression “bioprocess” presently represents any kind of biotechnological process, in particular biopharmaceutical processes. The operation of a chromatography arrangement with multiple chromatography columns, that are connected to a valve switching cassette for performing a simulated moving bed (SMB) chromatography, may be part of such a bioprocess.

The valve switching cassette in question may be applied in various fields of biotechnology. High cost efficiency and increasing flexibility in this field have been driven by the increasing demand for biopharmaceutical drugs. Cost efficiency is not only related to material costs, but also manufacturing costs. Flexibility is to be understood in a broad sense, referring to the operational scale of the bioprocessing installation as well as the mode of operation itself. For the valve switching cassette as part of the SMB process related to biopharmaceutical production, it is particularly important to keep the cleaning effort of the complex network of interconnected fluid lines and valves to a minimum. Thus, a disposable and compact design of the individual valves and connectors is essential. A valve switching cassette, designed as a single use item, is disclosed in EP 1 775 001 A1.

In the above noted, known valve switching cassette, which is the starting point for the disclosure, ports and fluid lines are organized in a compact manifold. The valve switching cassette comprises an array of switchable valve units for selectively interconnecting primary fluid lines with secondary fluid lines via transfer fluid lines. For realizing those primary and secondary fluid lines, that are arranged in rows and columns, numerous conduits are being machined into the manifold. With the known valve switching cassette, the primary and secondary fluid lines may be selectively interconnected in a very flexible way. However, the manufacture of the valve switching cassette is costly due to the fact, that the above noted conduits, which are to be machined into the manifold, are of considerable longitudinal extension and are usually realized by deep hole drilling. This cost issue is particularly relevant in view of the fact, that the manifold is often applied as a single use item.

### SUMMARY

It is therefore an object of the present disclosure to provide means that reduce the manufacturing costs for the valve switching cassette, keeping up the flexibility regarding the selective interconnection of fluid lines.

The above-noted problem is solved by various embodiments of the disclosure.

A premise for the disclosure is the valve switching cassette comprising at least one fluid flow system of ports and fluid lines, which fluid flow system includes primary ports, communicating with primary fluid lines, and secondary ports, communicating with secondary fluid lines. In addition, the valve switching cassette comprises an array of switchable valve units for selectively interconnecting the primary fluid lines with the secondary fluid lines via transfer fluid lines. This is the basis for the overall function of the valve switching cassette, namely to selectively interconnect primary and secondary fluid lines.

According to the disclosure, it now has been found that the fluid lines may well be established between a transfer plate with apertures and an elastically deformable membrane structure, which results in a new freedom for the layout and selective interconnection of the fluid lines.

In detail it is proposed that the valve switching cassette comprises a transfer plate with apertures and a membrane structure on each flat side of the transfer plate. At least part of the primary fluid lines and the secondary fluid lines are extending between the transfer plate and one of the membrane structures.

It is now possible to create fluid lines with considerable longitudinal extension without the need of costly machining such as deep hole drilling. The fluid wise coupling of the primary fluid lines and secondary fluid lines, which can be provided on opposite flat sides of the transfer plate, are realized by the transfer fluid lines. Those transfer fluid lines are at least partly provided by simple apertures in the transfer plate, which renders the transfer plate an easy to manufacture component.

It is now also possible to flexibly change the design of the fluid lines, as will be explained later. Another new constructional freedom is the possibility of using the membrane structure as part of the switchable valves, as will be explained later as well.

Finally, with the proposed solution, an undesirable generation of so called “dead legs” within the fluid lines is prevented. Those dead legs have no function within the bioprocess, but they are susceptible to retaining residual fluid. Mainly because of the elasticity of the membrane structure, residual fluid is being pressed out and thereby drained from the fluid lines. All in all, this leads to a reduction in hold-up volume. The expression “hold-up volume” refers to the volume of residual fluid that is retained within the valve switching cassette.

With the proposed solution, complex structures of fluid lines, that may selectively be interconnected, are easily possible. In particular, more than one above noted fluid flow system of ports and fluid lines may be utilized in a combined manner.

According to some embodiments, the primary fluid lines and the secondary fluid lines are located on opposite flat sides of the transfer plate. These make the selective interconnection via the transfer fluid lines and the valve units particularly simple in constructional view. Also it becomes clear that the manufacturing process is simplified, as the relatively short transfer fluid lines may be realized by simple drill bores.

The primary fluid lines and secondary fluid lines of the fluid flow systems may be defined in various ways. According to some embodiments, in one alternative the fluid flow is directed from a primary fluid line to a secondary fluid line in normal operation. As a result, the flow direction through the respective transfer fluid lines and the respective valve units is identical for all transfer fluid lines, which makes the valve construction particularly simple.

According to some embodiments, the valve units are designed as membrane valve units with a valve membrane, that is provided by at least one of the membrane structures. According to this, the respective membrane structure does not only serve to provide the primary and secondary fluid lines, but also to provide the valve membranes of the valve units. This leads to a compact and at the same time cost effective approach.

Various embodiments are directed to a particularly effective design of the array of valves. In particular the above noted use of the membrane structure for providing the valve membranes makes the valve units simple in construction with resulting cost benefits.

According to some embodiments, the membrane structures each comprise at least one membrane that extends along one flat side of the transfer plate. The membrane can be composed of fluorocarbon-based fluoroelastomers (FKM). FKM may be used with a wide variety of acids and bases, which enhances process flexibility.

The interaction of the valve switching cassette with an actuator block, which comprises a plunger system to selectively switch the array of valves, is subject of various embodiments. Here, the actuator block acting on the valve membrane is provided with at least one actuatable plunger. As the plunger can be out of contact from any fluid, the actuator block may be of simple construction.

According to some embodiments, the fluid lines are being established by elastic deformation of the membrane structure. Due to the elasticity of the membrane structure, the fluid lines may be inflated for conducting fluid and may collapse, after the conduct of fluid has been terminated. This is a simple way to realize the fluid lines and at the same time to drain residual fluid from the valve switching cassette after use due to the above noted elasticity of the membrane structure.

According to some embodiments, the valve switching cassette comprises at least one retainer frame that covers one of the membrane structures. This is an easy way to sealingly fix the membrane structure to the transfer plate.

A flexible way to define the shape of the fluid lines is proposed in some embodiments. According to this approach, the valve switching cassette comprises at least one channel plate covering the membrane structure, which channel plate defines the deformation of the membrane structure. As a result, a wide range of modifications to the structure of the primary fluid lines and/or the secondary fluid lines is possible simply by exchanging the channel plate. This way, not all parts of the valve switching cassette have to be exchanged, if modifications to the primary and/or secondary fluid lines are desired. Here the goal is to increase the flexibility of the valve switching cassette by simple means.

Some embodiments are directed to an optional solution for an interface between the fluid lines and the other components of the bioprocess installation. The interface conduit may, for example, be arranged within the transfer plate, which makes the overall arrangement more compact.

According to some embodiments, the valve switching cassette is sealed by a cassette enclosure. By such sealed design the above noted draining of the fluid lines within the valve switching cassette may be enhanced. By the introduction of gas or liquid pressure into the cassette enclosure, collapse of the fluid lines is supported. With the support of the collapse of the fluid lines, the fluid within the fluid lines of the valve switching cassette is effectively drained in a residue-free manner from the valve switching cassette. Moreover, the bioburden is further reduced by such sealed design.

Various embodiments are directed to a valve switching system with an above noted valve switching cassette, wherein the valve switching system comprises an actuator block assigned to the valve switching cassette. The actuator block acts on the membrane structure of the valve switching cassette for it to selectively engage the respective valve seat. Reference is made to all explanations given with regard to the proposed valve switching cassette and its interaction with such actuator block.

Various embodiments are directed to the bioprocess installation as such. Reference is made to all explanations given with regard to the proposed valve switching system and valve switching cassette.

According to some embodiments, the bioprocess installation comprises a chromatography arrangement with multiple chromatography columns that are connected to the valve switching cassette. Due to the flexibility in selectively interconnecting the various fluid lines, the combination of the proposed valve switching cassette with such chromatography arrangement is advantageous.

In various embodiments, a method for operating the proposed valve switching system with its valve switching cassette is provided. As this represents the normal operation of the proposed valve switching system with its valve switching cassette, again, reference may be made to all explanations given with regard to the proposed valve switching system and valve switching cassette.

Various embodiments provide a valve switching cassette for selectively interconnecting components of a bioprocess installation, wherein the valve switching cassette comprises at least one fluid flow system of ports and fluid lines, which includes primary ports, communicating with primary fluid lines, and secondary ports, communicating with secondary fluid lines, wherein the valve switching cassette comprises an array of switchable valve units for selectively interconnecting the primary fluid lines with the secondary fluid lines via transfer fluid lines, wherein the valve switching cassette comprises a transfer plate with apertures and an elastically deformable membrane structure on each flat side of the transfer plate, that at least part of the primary fluid lines and secondary fluid lines are extending between the transfer plate and one of the membrane structures and that the transfer fluid lines are at least partly provided by the apertures.

In some embodiments, the at least one fluid flow system includes said first fluid flow system of ports and fluid lines, which first fluid flow system includes said primary ports, communicating with said primary fluid lines, and said secondary ports, communicating with said secondary fluid lines, and that the at least one fluid flow system includes an additional, second fluid flow system of ports and fluid lines, which second fluid flow system includes primary ports, communicating with primary fluid lines, and secondary ports, communicating with secondary fluid lines, that the array of valve units also serves to selectively interconnect fluid lines, the secondary fluid lines, of the first fluid flow system with fluid lines, the primary fluid lines, of the second fluid flow system.

In some embodiments, the primary fluid lines and the secondary fluid lines are located on opposite flat sides of the transfer plate, and/or, that the transfer fluid lines extend laterally with respect to the respective flat side of the transfer plate.

In some embodiments, the fluid flow is directed from the primary fluid lines to the secondary fluid lines.

In some embodiments, the valve units are designed as membrane valve units each with a valve membrane and that the valve membranes of the valve units are provided by at least one of the membrane structures, that a relative movement of the valve membranes mediates the opening or closing of the valve units.

In some embodiments, the valve units each comprise a valve seat and that the valve membrane, provided by one of the membrane structures, may selectively engage the valve seat as to switch the valve units, that a movement of the respective valve membrane relative to the assigned valve seat mediates their selective engagement for switching the valve units.

In some embodiments, for each valve unit, one of the fluid lines, such as one of the secondary fluid lines, and one of the transfer fluid lines lead into the valve seat and may sealingly interact with the valve membrane provided by the membrane structure.

In some embodiments, for each valve unit, the valve seat is localized in the respective transfer fluid line, that each transfer fluid line comprises at least one assigned valve seat.

In some embodiments, the membrane structures each comprise at least one membrane, that extends along one flat side of the transfer plate, that the membrane is composed of a fluorocarbon-based fluoroelastomer.

In some embodiments, the valve switching cassette interacts with an actuator block, which acts on the membrane structure for it to selectively engage the respective valve seat, that the actuator block comprises a plunger system with at least one plunger for acting on the membrane structure.

In some embodiments, the primary fluid lines and/or the secondary fluid lines can acquire a first, inflated state, set up to create a fluidic connection within the respective fluid line, and a second, collapsed state, set up to end the fluidic connection within the respective fluid line, that the inflated state is created by fluid pressure established by the presence of fluid influx into the respective fluid line and the elastic deformation of the membrane structure and that the collapsed state is created by the absence of fluid influx and the elastic resilience of the membrane structure.

In some embodiments, the valve switching cassette comprises at least one retainer frame covering one of the membrane structures at its flat side opposite the transfer plate, which retainer frame provides a detachable or non-detachable, fluid tight connection between the membrane structure and the transfer plate.

In some embodiments, the valve switching cassette comprises at least one channel plate covering the membrane structure, which channel plate comprises holes enabling the plungers to engage with the deformed membrane structure, which channel plate comprises a plurality of channels, that define the deformation of the membrane structure into channel like primary fluid lines and channel like secondary fluid lines, that in the properly assembled state the fluid lines are arranged horizontally and the fluid lines are arranged vertically on the channel plate.

In some embodiments, the ports each comprise a common interface conduit at or within the transfer plate, which interface conduit extends from one of the narrow sides of the transfer plate to one of the fluid lines, that the junction between the interface conduit and the respective fluid line provides an interface valve seat and that a valve membrane, provided by the membrane structure, may engage the valve seat as to provide a pressure valve.

In some embodiments, the valve switching cassette comprises at least one cassette enclosure, which is assigned to one of the membrane structures and which defines a sealed interior between the cassette enclosure and the membrane structure, that the channel plate is arranged between the membrane structure and the cassette enclosure, further that the cassette enclosure comprises a cassette enclosure inlet, which is set up to introduce pressure, such as pressure by gas or liquid, into the sealed interior, such as to purge out liquid out of the at least one fluid flow system.

Various embodiments provide a valve switching system with a valve switching cassette as described herein, wherein the valve switching system comprises an actuator block assigned to the valve switching cassette, wherein the actuator block acts on the membrane structure of the valve switching cassette for it to selectively engage the respective valve seat, that the actuator block comprises a plunger system with at least one plunger for acting on the membrane structure of the assigned valve switching cassette.

Various embodiments provide a bioprocess installation, comprising a valve switching system as described herein and a component to be selectively interconnected by the valve switching cassette of the valve switching system.

In some embodiments, as a component to be selectively interconnected, the bioprocess installation comprises a chromatography arrangement with multiple chromatography columns, that are connected to the valve switching cassette of the valve switching system as described herein for performing a simulated moving bed chromatography process.

Various embodiments provide a method for operating a valve switching system as described herein, wherein valve membranes are provided by the membrane structure, which are selectively engaged as to switch the valve units.

### BRIEF DESCRIPTION OF THE DRAWINGS

In the following, an embodiment is explained with respect to the drawings. In the drawings show

FIG. 1 a proposed bioprocess installation with a proposed valve switching cassette,

FIG. 2 an exploded view of the proposed valve switching cassette according to FIG. 1,

FIG. 3 the valve switching unit according to FIG. 1 in a cross-sectional view and

FIG. 4 part of the bioprocess installation according to FIG. 1 in an exemplary mode of operation.

### DETAILED DESCRIPTION

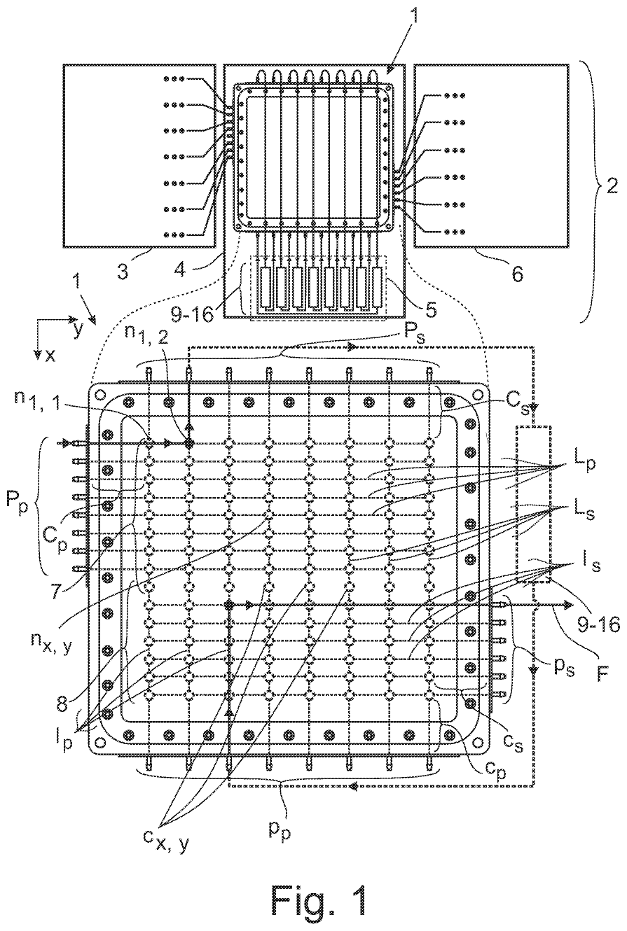

As shown in FIG. 1, the proposed valve switching cassette 1 is designed for selectively interconnecting a component of a bioprocess installation 2 with another component of the bioprocess installation 2. The expression “interconnecting” is to be understood in the sense of a fluid connection.

In particular, FIG. 1 depicts the consecutive steps carried out for recovery and purification of a desired product, such as a monoclonal antibody, as part of the downstream process within a bioprocess. In the first steps of the downstream process, the product is isolated in an isolation unit 3. Assuming that the product is located in the supernatant of the fermentation broth, which typically is the case for example for secreted monoclonal antibodies, centrifugation may be carried out in order to separate the product from the cells and cell debris. To increase the product concentration and to reduce the volume of material to be handled in the consecutive downstream processing steps, concentration, for example by ultrafiltration, may also be carried out as part of the product isolation.

After product isolation in the isolation unit 3, product purification is performed in a purification unit 4. Product purification may be carried out by different means, including column chromatography, as depicted in FIG. 1 by a chromatography arrangement 5. Compared to traditional single column chromatography, multi-column chromatography significantly increases the efficiency of the purification step. However, especially regarding the fluid flow, multi-column chromatography is more complex than single column chromatography. Therefore, advanced control of the fluid flow path F is necessary, which presently is achieved by using a proposed valve switching cassette 1 as shown in FIG. 1.

Product purification is typically followed by product polishing in a polishing unit 6. At the end of product polishing, the product is typically packaged for further distribution. Depending on the bioprocess, the product polishing may for example include a virus inactivation step to comply with regulatory requirements. Another example for product polishing is a crystallisation step to convert the fluid product into a solid, and thereby easily transportable, form.

The valve switching cassette 1 comprises at least one fluid flow system 7, 8 of ports Pₚ, Pₛ and fluid lines Lₚ, Lₛ, T, which fluid flow system 7, 8 includes primary ports Pₚ, communicating with primary fluid lines Lₚ, and secondary ports Pₛ, communicating with secondary fluid lines Lₛ. The valve switching cassette 1 also comprises an array of switchable valve units n_{x,y} for selectively interconnecting the primary fluid lines Lₚ with the secondary fluid lines Lₛ via transfer fluid lines T.

The expression “port” represents the interface for interconnecting components of the bioprocess installation 2 to the respective fluid line. It may include a fluid connector and a conduit like arrangement to the respective fluid line, as will be explained later.

The expression “line” represents any longitudinal volume, that may hold and guide fluid between two locations. A line in this sense may also include an inflatable and collapsible conduit structure, as well be explained later as well.

The expressions “primary” and “secondary” are used to differentiate between the two groups of fluid ports to be interconnected by the valve units n_{x,y}. In the shown embodiment, those expressions also indicate the direction of fluid flow, which is then directed from the primary fluid port to the secondary fluid port. However, this can be realized the other way around as well. Accordingly, the expressions “primary” and “secondary” neither imply nor exclude a constructional and/or functional difference between the respective ports and fluid lines.

The expression “selectively interconnecting” means, that one or more of the primary fluid lines Lₚ may be selected to be interconnected with one or more of the secondary fluid lines Lₛ.

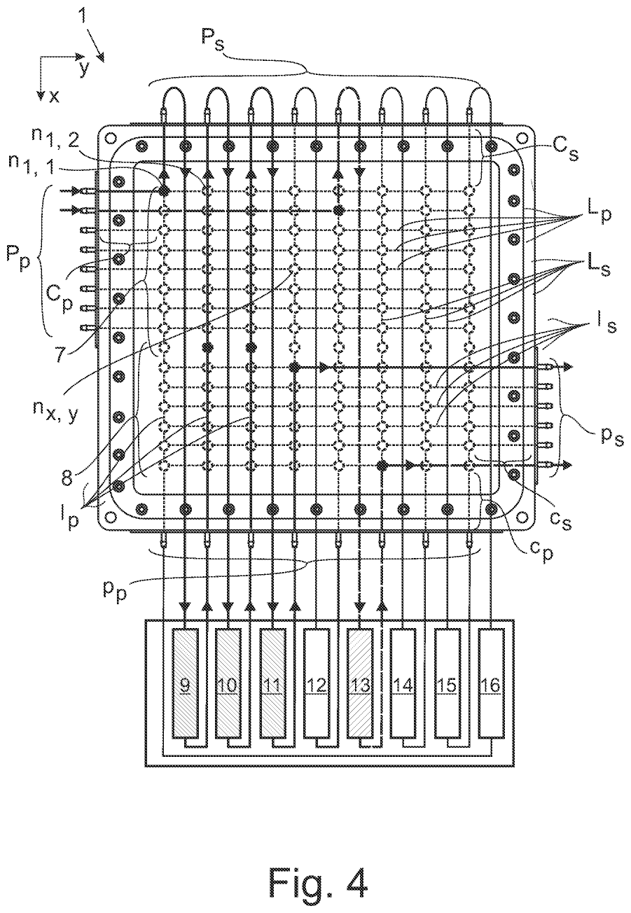

The expression “switchable” refers to the possibility of changing the valve unit n_{x,y} from the state “valve open” to the state “valve close” or from the state “valve close” to the state “valve open”. If the valve unit n_{x,y} is in the state “valve open”, fluid may flow from a primary fluid line Lₚ via the transfer fluid line T into a secondary fluid line Lₛ. The open valve units n_{x,y} are indicated as solid circles in FIG. 1 and FIG. 4. If the valve unit n_{x,y} is in the state “valve close”, fluid flow from the primary fluid line Lₚ via the transfer fluid line T into the secondary fluid line Lₛ is prevented. The closed valve units are indicated as outlined circles in FIG. 1 and FIG. 4.

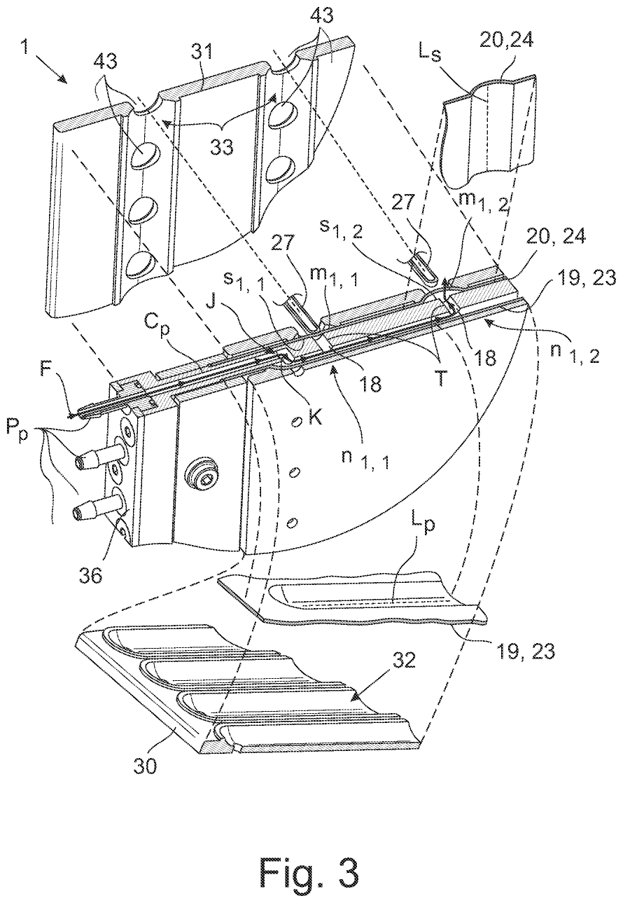

The primary fluid lines Lₚ and the secondary fluid lines Lₛ can be arranged in rows and columns and on different sides of the valve switching cassette 1, wherein the valve units n_{x,y} are located at each junction between a primary fluid line Lₚ and a secondary fluid line Lₛ, such that the respective fluid lines Lₚ, Lₛ may be interconnected by the respective valve unit n_{x,y}. Accordingly, the array of valve units n_{x,y} is aligned to those rows and columns and numbered accordingly. The valve units n_{1,1} and n_{1,2} are shown in detail in FIG. 3.

In some embodiments, the proposed valve switching cassette 1 serves for controlling the fluid flow of a component to be selectively interconnected such as the shown chromatography arrangement 5. Fluids to be handled within the present embodiments can include a wide variety of liquid media such as buffers, wash solutions, acids, bases, culture media, unprocessed product-containing liquids, partly processed product-containing liquids, purified product-containing liquids, sanitation solutions etc. Fluids to be handled within the disclosed embodiments may also be media in the gas phase.

The valve switching cassette 1 comprises a transfer plate 17 with apertures 18 and an elastically deformable membrane structure 19, 20 on each flat side 21, 22 of the transfer plate 17. Accordingly, the membrane structures 19, 20 are each in contact with a flat side 21, 22 of the transfer plate 17.

The expression “aperture” is to be understood as an opening in the transfer plate 17, extending through the complete thickness of the transfer plate 17, which thickness is extending laterally with respect to the xy-plane in FIG. 1.

At least part of the primary fluid lines Lₚ and secondary fluid lines Lₛ are extending between the transfer plate 17 and one of the membrane structures 19, 20. This means, that the fluid lines are extending along the respective flat side 21, 22 of the transfer plate 17. This also means, that the fluid lines are at least partly provided by the respective membrane structure 19, 20. The transfer fluid lines T are at least partly provided by the apertures 18 within the transfer plate 17.

The shown embodiment includes not only the above noted fluid flow system, which in the following is depicted as “first” fluid flow system 7, but also a “second” fluid flow system 8.

As noted above, the first fluid flow system 7 includes primary ports Pₚ, communicating with said primary fluid lines Lₚ, and secondary ports Pₛ, communicating with said secondary fluid lines Lₛ.

The second fluid flow system 8 includes primary ports pₚ, communicating with primary fluid lines lₚ, and secondary ports pₛ, communicating with secondary fluid lines Is.

In addition to interconnecting primary fluid lines and secondary fluid lines within the fluid flow systems 7, 8, the array of valve units n_{x,y} also serves to selectively interconnect fluid lines, here the secondary fluid lines Lₛ, of the first fluid flow system 7, with fluid lines, here the primary fluid lines lₚ, of the second fluid flow system 8. For this purpose, the array of valve units n_{x,y} can comprise an additional row of valve units c_{x,y}, indicated in FIG. 1.

The general functionality of the two fluid flow systems 7, 8 of ports and fluid lines with regard to selectively interconnecting the respective fluid lines is identical, such that explanations given for one fluid flow system 7, 8 are equally applicable for the respective other fluid flow system 8, 7. In the following, reference is made mainly to the first fluid flow system 7, in order to keep complexity down.

In the shown embodiment, the primary ports Pₚ of the first fluid flow system 7 provide the inlets of the purification unit 4, while the secondary ports pₛ of the second fluid flow system 8 provide the outlets of the purification unit 4.

As shown in FIG. 1 and as indicated above, the component to be selectively interconnected is an above noted chromatography arrangement 5 with multiple chromatography columns 9-16 for performing simulated moving bed (SMB) chromatography. Here, the primary fluid ports Pₚ of the first fluid flow system 7 are used as inlets for feed, eluent, washing buffer etc. These are selectively guided to the inlets of the chromatography columns 9-16 by selectively interconnecting the primary fluid lines Lₚ with the secondary fluid lines Lₛ of the first fluid flow system 7. The outlets of the chromatography columns 9-16 are connected to the primary ports pₚ and with it to the primary fluid lines lₚ of the second fluid flow system 8, which are selectively interconnected with the secondary fluid line lₛ and with it the secondary ports pₛ of the second fluid flow system 8.

FIG. 4 shows just another exemplary operation of the proposed valve switching unit 1. Here it becomes clear, that numerous variants of sequential and parallel utilization of the chromatography columns 9-16 is possible. While the chromatography columns 9, 10, 11 are utilized in sequence, the chromatography column 13 is utilized in parallel thereto. All in all, fluid flow F can be directed from any one of the inlets provided by primary ports Pₚ of the first fluid flow system 7 to any one of the outlets provided by the secondary fluid ports pₛ of the second fluid flow system 8, utilizing any number of chromatography columns 9-16 in any desired sequential or parallel manner.

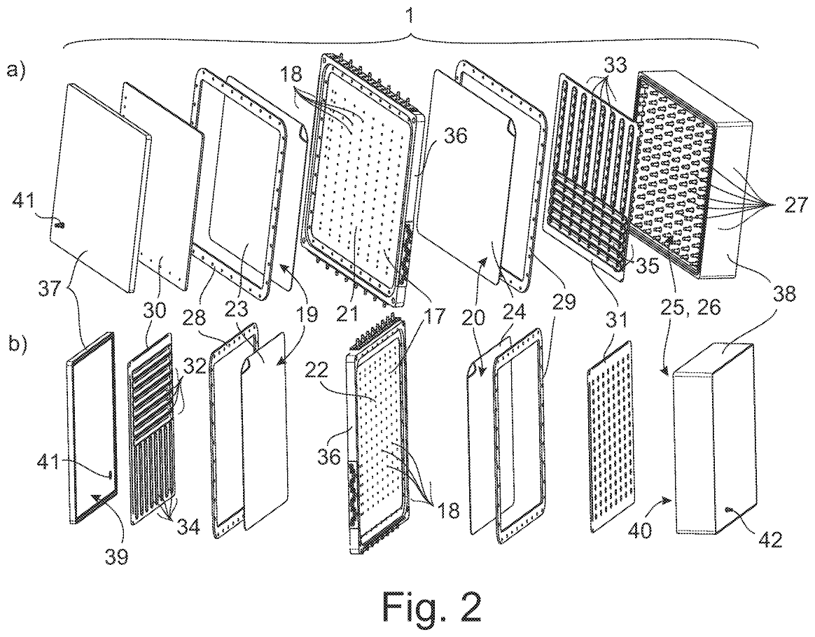

As indicated above, the primary fluid lines Lₚ can be located as horizontal rows, and the secondary fluid lines Lₛ can be located as vertical columns. Moreover, they can be located on opposite flat sides 21, 22 of the transfer plate 17. As shown in FIG. 2, the primary fluid lines Lₚ are arranged on one flat side 21 of the valve switching cassette 1, while the secondary fluid lines Lₛ are arranged on the other flat side 22 of the valve switching cassette 1. This can be provided for both fluid flow systems 7, 8: The primary fluid lines Lₚ, lₚ of each fluid flow system 7, 8 are here located on one flat side 21 of the transfer plate 17, while the secondary fluid lines Lₛ, lₛ of each fluid flow system 7, 8 are located on the respective other flat side 22 of the transfer plate 17.

As an alternative or in addition, the fluid flow F is always directed from the primary fluid lines Lₚ, lₚ to the secondary fluid lines Lₛ, lₛ. This is at least provided within each fluid flow system 7, 8.

For easy manufacturing, the transfer fluid lines T can extend laterally with respect to the respective flat side 21, 22 of the transfer plate 17. The transfer plate 17 with its transfer fluid lines T is then of particularly simple mechanical structure and may be produced with low costs. The transfer plate 17 may be made of any kind of, such as acrylic, plastic material such as PMMA, PEEK or PVDF. The transfer fluid lines T may be introduced into the transfer plate 17 by drilling, punching, injection molding or the like.

Due to its simple structure, the transfer plate 17 may be relatively thin, which as a first aspect makes the valve switching cassette 1 lightweight. The thickness of the transfer plate 17 can be less than 40 mm, further less than 30 mm, further less than 20 mm, which also renders the manufacturing of the transfer fluid lines T to be no challenge at all.

The realization of the valve units n_{x,y} is particularly simple as well. In detail, the valve units n_{x,y} are designed as membrane valve units, each with a valve membrane m_{x,y}, which may be moved between an open (FIG. 3, valve unit n_{1,2}) and a closed position (FIG. 3, valve unit n_{1,1}).

Each valve membrane m_{x,y} is provided by at least one of the membrane structures 19, 20, here by the membrane structure 20. Accordingly, the membrane structures 19, 20 are used in two ways: Firstly, as noted above, for providing at least part of the fluid lines Lₚ, Lₛ, and secondly for providing the valve membranes m_{x,y}. This double use of the membrane structure 19, 20 leads to a compact, easy to manufacture and cost-effective realization of the proposed valve switching cassette 1.

In some embodiments, each membrane structure 19, 20 comprises at least one membrane 23, 24, that extends along one flat side 21, 22 of the transfer plate 17.

In the shown embodiment, at least one of the membrane structures 19, 20 comprises exactly one membrane 23, 24, which is a one piece component. In some embodiments, both membrane structures each comprise exactly one membrane 23, 24, which is a one piece component.

The valve units n_{x,y} each comprise a valve seat s_{x,y}, wherein the respective valve membrane m_{x,y}, provided by the membrane structure 20, may selectively engage the valve seat s_{x,y}(state “valve closed”) or disengage the valve seat s_{x,y} (state “valve open”) as to switch the valve units n_{x,y}. As shown in FIG. 3, for each valve unit n_{x,y}, one of the fluid lines Lₚ, Lₛ and one of the transfer fluid lines T can lead into the valve seat s_{x,y} and may sealingly interact with the valve membrane m_{x,y} provided by the membrane structure 20.

FIG. 3 shows, that for each valve unit n_{x,y}, the valve seat s_{x,y} is localized in the respective transfer fluid line T. FIG. 3 also shows, that for each valve unit n_{x,y}, the valve seat s_{x,y} is localized in the respective secondary fluid line Lₛ. In some embodiments, each transfer fluid line T comprises at least one assigned valve seat s_{x,y}. As shown in FIG. 3, this may easily be realized by using the opening of the respective transfer fluid line T as the valve seat s_{x,y}.

For the membranes 23, 24 of the membrane structures 19, 20, different materials may be applied. In some embodiments, the membranes 23, 24 are composed of a fluorocarbon-based fluoroelastomer (FKM), which is a rubber compound that uses vinylidene fluoride as its monomer. The material FKM is robust even when in contact with critical fluids such as a variety of acids and bases as noted above. The hardness (Shore A) lies between 50 and 80, further at 75. The material thickness of the membranes 23, 24 can be less than 3 mm and further between 0.75 mm and 1.5 mm.

The membrane structures 19, 20 may be of identical layout in view of material and/or geometry, in particular thickness, for each flat side 21, 22 of the transfer plate 17, which is logistically advantageous. However, due to cost optimization, it may be possible to choose different layouts for the membrane structures 19, 20.

As noted above, the valve units n_{x,y} are switchable for selectively interconnecting the primary fluid lines Lₚ with the secondary fluid lines Lₛ. For this, the valve switching cassette 1 can interact with an actuator block 25, which acts on the membrane structure 20 for it to selectively engage the respective valve seat s_{x,y}. The valve switching cassette 1 and the actuator block 25 in combination add up to a valve switching system noted below. The interaction between the actuator block 25 and the membrane structure 19 may be performed in different ways and based on different physical principles.

As shown in FIG. 2 and FIG. 3, the actuator block 25 comprises a plunger system 26 with at least one plunger 27 for acting on the membrane structure 20. The plunger may be moved into engagement with and out of engagement from the membrane structure 20, in particular the valve membrane m_{x,y}, which results in the membrane structure 20 coming into sealing engagement or out of sealing engagement from the valve seat s_{x,y}. For this, an actuator (not shown) is assigned to each of the plungers 27, which may be driven pneumatically, hydraulically, electro-magnetically or the like. It may be pointed out, that the expression “coming into sealing engagement” represents establishing a fluid tight sealing, normally force fit engagement between the membrane structure 20 and the valve seat s_{x,y}, while the expression “coming out of sealing engagement” may include a loose contact between the membrane structure 20 and the valve seat s_{x,y}, which however is not fluid tight.

As an alternative, the actuator block 25 may act on the membrane structure 20 in a contact free manner, in particular pneumatically or hydraulically by applying a gas or liquid onto the membrane structure 20 and the valve membrane m_{x,y} respectively. In this case, plunger 27 may be omitted, which reduces mechanical wear.

Here, the array of valve units n_{x,y} is realized on only one flat side 22 of the transfer plate 17, here on the side, on which the secondary fluid lines Lₛ are realized. This leads to an easy construction of the actuator block 25, which then also has to engage the one membrane structure 20 on the flat side 22. Generally, however, it is possible, to realize the array of valve units n_{x,y} on both flat sides 21, 22 of the transfer plate 17.

The actuator block 25 may be controlled by an electronic control (not shown), including a microprocessor, operated based on a control software. Here it becomes apparent that the complete fluid flow can be flexibly modified electronically just by a corresponding modification of the control software. It is for example possible to change the configuration of any of the ports by control software modification.

As a particularly simple realization of the respective fluid lines it can be, that the primary fluid lines Lₚ and/or the secondary fluid lines Lₛ can acquire a first, inflated state, which is set up to create a fluidic connection within the respective fluid line Lₚ, Lₛ, and a second, collapsed state, which is set up to end the fluidic connection within the respective fluid line. Due to the elasticity of the membrane structure 19, 20, the fluid lines are inflatable against the elastic resilience of the membrane structure 19, 20. The inflated state is shown in FIG. 3 for the primary fluid line Lₚ as well as for the secondary fluid line Lₛ in the area of valve unit n_{1,2}, while the collapsed state is shown in FIG. 3 for the secondary fluid line Lₛ in the area of valve unit n_{1,1}.

The inflated state may be created by fluid pressure established by the presence of fluid influx into the respective fluid line Lₚ, Lₛ and the elastic deformation of the membrane structure 19, 20. This deformation is mainly directed in a direction lateral with respect to the respective flat side 21, 22 of the transfer plate 17. In some layouts, a fluid pressure of the fluid influx of at least 0.08 bar, or of 0.1 bar, is sufficient to cause the respective fluid line to inflate. The collapsed state may be created by the absence of fluid influx and the elastic resilience of the membrane structure 19, 20.

The above noted, inflatable fluid lines are simple to realize and offer an almost unrestricted flexibility in view of their design. In addition, it is possible to choose a layout for the membrane structures 19, 20, such that residual fluid is being drained out of the fluid lines just by the resilience of the membrane structures, as far as the respective fluid lines are open at their respective end.

In some embodiments, the valve switching cassette 1 comprises at least one retainer frame 28, 29 covering one of the membrane structures 19, 20 at its flat side opposite the transfer plate 17. The retainer frame 28, 29 provides a detachable, fluid tight connection between the membrane structure 19, 20 and the transfer plate 17, as shown in FIG. 2. Accordingly, no adhesive is necessary to connect the membrane structure 19, 20 to the transfer plate 17, which makes it generally possible to exchange the membrane structure 19, 20 and/or dispose the membrane structure 19, 20 separately from the transfer plate 17. According to another embodiment the membrane structure 19, 20 may be permanently attached to the transfer plate 17 by alternative manufacturing techniques, such as riveting, thermoplastic fusion bonding or encapsulated plastic molding.

As shown in FIG. 3, the valve switching cassette 1 comprises at least one channel plate 30, 31, here one channel plate 30, 31 for each flat side 21, 22 of the valve switching cassette 1, which channel plates 30, 31 are each covering a membrane structure 19, 20 at its respective flat side opposite the transfer plate 17. Here, the respective membrane structure 19, 20 is sandwiched between the respective flat side 21, 22 of the transfer plate and the respective channel plate 30, 31. The channel plates 30, 31 may also be assigned to an above noted retainer frame 28, 29 for jointly providing the leak-free connection between the membrane structure 19, 20 and the transfer plate 17.

Each channel plate 30, 31 comprises a plurality of channels 32-35, wherein channels 32, 35 can be arranged in horizontal rows and wherein channels 33, 34 can be arranged in vertical columns to define the, such as horizontal fluid lines Lₚ/lₛ and the, optionally vertical fluid lines Lₛ/lₚ, respectively. These channels 32-35 define the deformation of the membrane structure 19, 20 into channel like primary fluid lines Lₚ and channel like secondary fluid lines Lₛ. The channels 32, 33 define the primary fluid lines Lₚ and the secondary fluid lines Lₛ of the first fluid flow system 7, while the channels 34, 35 define the primary fluid lines lₚ and the secondary fluid lines lₛ of the second fluid flow system 8.

The channels 32-35 of the channel plates 30, 31 are open with respect to the assigned membrane structure 19, 20, such that the membrane structures 19, 20 may deform into the channels 32-35 and conform with the channels 32-35. Accordingly, the channels 32-35 form grooves in the channel plates 30, 31 with a certain cross-sectional form, such as an arcuate, polygonal, in particular rectangular form. The cross-sectional form defines the cross-sectional form of the resulting fluid line, as the membrane structure 19, 20, during inflating the respective fluid line, attaches the wall of the respective channel 32-35, which limits and thereby defines the deformation of the membrane structure 19, 20. In another embodiment, it is possible to have the channels in a non-linear manner, such as in a loop-back path, which will be defined by the path cut in the channel plates 30, 31.

In some embodiments, the channel plates 30, 31 are in constant force fit connection with the membrane structures 19, 20, pressing the membrane structures 19, 20 onto the respective flat side 21, 22 of the transfer plate 17. The channels 32-35 are integrated into the flat side of the membrane structure 19, 20, which is facing the respective membrane structure 19, 20, such that the channel free areas on the channel plates 30, 31 press the membrane structures 19, 20 onto the respective flat side 21, 22 of the transfer plate 17, preventing an elastic deformation and with it the inflating of a fluid line. In the areas of the channels 32-35, however, elastic deformation and with it the inflating of a fluid line is well possible. This shows, that the design of the fluid lines may easily be modified just by designing the channel plates 30, 31 accordingly.

It may be pointed out here, that the characteristics of the channels 32-35 represent only an exemplary configuration. All aspects of the channels 32-35 can be designed as desired. For example, the channels can be of a different size and/or geometry.

The working principle of the channel plates 30, 31 may be derived from FIG. 3. The channels 32-35 define the volume, into which the membrane structure 19, 20 can deform during inflating the fluid lines, and thereby define the resulting design of the inflated fluid lines. This is shown in FIG. 3 for the primary fluid line Lₚ and the secondary fluid line Lₛ in the area of valve unit n_{1,2}.

It may be pointed out, that the channel plates 30, 31 according to the disclosure are always out of contact from the fluid flowing through the fluid lines. This means, that the connection between the channel plates 30, 31 and the membrane structures 19, 20 may be free of sealing, which further simplifies manufacture. This also means that the materials of the channel plates do not have to be chemically resistant or inert to the flowing fluids as they are not part of the wetted path. In addition, it is possible to engage the membrane structures 19, 20 through openings in the channel plates 30, 31. This is shown in FIG. 2 and FIG. 3, according to which the channel plate 31 comprises holes 43, through which the plungers 27 are extending for engagement of the membrane structure 20.

As noted above, for each valve unit n_{x,y}, the valve seat s_{x,y} is localized in the respective secondary fluid line Lₛ. This means that the actuator block 25 acts on the membrane structure 20, and on the valve membrane m_{x,y} respectively, in the area of this secondary fluid line Lₛ. In some embodiments, the design is such that the actuator block 25 acting on the valve membrane m_{x,y} does not intercept the secondary fluid line Lₛ at the valve membrane m_{x,y}. As a result, fluid may pass the actuated valve membrane m_{x,y} along the secondary fluid line Lₛ, independent from the state of the respective valve unit n_{x,y}.

Each of the ports Pₚ, Pₛ, pₚ, pₛ can comprise an interface conduit Cₚ, Cₛ, cₚ, cₛ within the transfer plate 17, which interface conduit Cₚ, Cₛ, cₚ, cₛ extends from one of the narrow sides 36 of the transfer plate 17 to one of the fluid lines Lₚ, Lₛ, lₚ, lₛ. Those interface conduits Cₚ, Cₛ, cₚ, cₛ are identical for the two fluid flow systems 7, 8, such that they will be described with respect to the first fluid flow system 7 only. All explanations given are fully applicable to the interface conduits cₚ, cₛ of the second fluid flow system 8.

FIG. 3 shows, that the junction J between the interface conduit Cₚ and the respective fluid line Lₚ provides an interface valve seat K and that a valve membrane, provided by the membrane structure 19, 20, may engage the valve seat as to provide a pressure valve. The pressure valve prevents fluid from flowing through the valve, until a predefined threshold pressure is reached in the fluid. This not only results in the function of a check valve, preventing inflowing fluid from flowing back in an uncontrolled manner, it makes it possible to exactly define the fluidic system characteristic by predefining the pressure threshold.

The interface conduits Cₚ, Cₛ can be drilled into the transfer plate 17. It is also possible, however, that the interface conduits Cₚ, Cₛ are realized by injection molding, if the transfer plate 17 is made of plastic material. Due to the reduced length of the conduits Cₚ, Cₛ, the above advantage of easy manufacturing of the transfer plate 17 is not compromised.

It is of utmost importance, that the fluid lines may be completely emptied after operation or in between different operation steps of the valve switching cassette 1. To realize this, it can be, that the valve switching cassette 1 comprises at least one cassette enclosure 37, 38, which is assigned to one of the membrane structures 19, 20 and which defines a sealed interior 39, 40 between the cassette enclosure 37, 38 and the membrane structure 19, 20. This at least one cassette enclosure 37, 38 significantly reduces the hold-up volume at the end of a bioprocess. It transfers remaining, valuable product to the next step in the chromatography process and also helps purge out waste buffers out of the at least one fluid flow system 7, 8, so that the actual disposable waste retained in the valve switching cassette is minimized.

In order to introduce pressure, such as pressure by gas or liquid, into the sealed interior 39, 40 and thereby to support the collapse of the fluid lines, the cassette enclosure 37, 38 comprises a cassette enclosure inlet 41, 42. For optimized results, it is possible to provide two cassette enclosures 37, 38, which are each assigned to one of the flat sides 21, 22 of the valve switching cassette 1. Depending on whether pressure by gas or liquid is applied, respective sealing between the cassette enclosure 37 and the membrane structure 19, 20 is to be realized.

In some embodiments, as shown in FIG. 2 and FIG. 3, the channel plate 30, 31 are each arranged between the membrane structure 19, 20 and the cassette enclosure 37, 38, which, for the above noted draining, makes it necessary to allow gas or liquid to flow through the channel plate 30, 31. This may easily be realized by a number of openings in the channel plate 30, 31.

FIG. 2 gives an overview of the overall structure of the proposed valve switching cassette 1. It becomes apparent, that the valve switching cassette 1 is mostly composed of parts that do not impose difficulties and/or costs for manufacturing. This is particularly advantageous, if the application of single use items is intended, for example in order to prevent (cross) contamination.

As may be taken from FIG. 2, only the transfer plate 17 and the membrane structures 19, 20 are in contact with the fluid flowing through the fluid lines and that those components are especially easy to manufacture. All other components are out of contact from the fluid flowing through the fluid lines, such that they may be reused with no particular cleaning effort.

According to a second teaching, the valve switching system with the proposed valve switching cassette 1 and the proposed actuator block 25 assigned to the valve switching cassette 1 is provided. Reference is made to all explanations given regarding the previous teaching.

According to a third teaching, the bioprocess installation 2 is provided. This bioprocess installation 2 comprises the component to be selectively interconnected, which here is the chromatography arrangement 5 with its multiple chromatography columns 9-16, that are connected to the valve switching cassette 1 for performing a simulated moving bed (SMB) chromatography process for example. Reference is made to all explanations given regarding the previous teachings.

According to a fourth teaching, the method for operating the valve switching system and the valve switching cassette 1 respectively is provided. Here it is essential, that the above noted valve membranes m_{x,y} are provided by the membrane structure 19, 20, which are selectively engaged as to switch the valve units n_{x,y}. Again, reference is made to the previous explanations given for the previous teachings.

Finally it may be pointed out, that the valve switching cassette 1 according to the various teachings may be subject to scale-up to different levels of batch size without having to introduce structural modifications.

1. A valve switching cassette for selectively interconnecting components of a bioprocess installation, wherein the valve switching cassette comprises at least one fluid flow system of ports and fluid lines, which includes primary ports, communicating with primary fluid lines, and secondary ports, communicating with secondary fluid lines, wherein the valve switching cassette comprises an array of switchable valve units for selectively interconnecting the primary fluid lines with the secondary fluid lines via transfer fluid lines,
wherein the valve switching cassette comprises a transfer plate with apertures and an elastically deformable membrane structure on each flat side of the transfer plate, that at least part of the primary fluid lines and secondary fluid lines are extending between the transfer plate and one of the membrane structures and that the transfer fluid lines are at least partly provided by the apertures.

2. The valve switching cassette according to claim 1, wherein the at least one fluid flow system includes said first fluid flow system of ports and fluid lines, which first fluid flow system includes said primary ports, communicating with said primary fluid lines, and said secondary ports, communicating with said secondary fluid lines, and that the at least one fluid flow system includes an additional, second fluid flow system of ports and fluid lines, which second fluid flow system includes primary ports, communicating with primary fluid lines, and secondary ports, communicating with secondary fluid lines.

3. The valve switching cassette according to claim 1, wherein the primary fluid lines and the secondary fluid lines are located on opposite flat sides of the transfer plate, and/or, that the transfer fluid lines extend laterally with respect to the respective flat side of the transfer plate.

4. The valve switching cassette according to claim 1, wherein the fluid flow is directed from the primary fluid lines to the secondary fluid lines.

5. The valve switching cassette according to claim 1, wherein the valve units are designed as membrane valve units each with a valve membrane and that the valve membranes of the valve units are provided by at least one of the membrane structures.

6. The valve switching cassette according to claim 5, wherein the valve units each comprise a valve seat and that the valve membrane, provided by one of the membrane structures, may selectively engage the valve seat as to switch the valve units.

7. The valve switching cassette according to claim 6, wherein for each valve unit, one of the fluid lines and one of the transfer fluid lines lead into the valve seat and may sealingly interact with the valve membrane provided by the membrane structure.

8. The valve switching cassette according to claim 6, wherein for each valve unit, the valve seat is localized in the respective transfer fluid line.

9. The valve switching cassette according to claim 1, wherein the membrane structures each comprise at least one membrane, that extends along one flat side of the transfer plate.

10. The valve switching cassette according to claim 6, wherein the valve switching cassette interacts with an actuator block, which acts on the membrane structure for it to selectively engage the respective valve seat.

11. The valve switching cassette according to claim 1, wherein the primary fluid lines and/or the secondary fluid lines can acquire a first, inflated state, set up to create a fluidic connection within the respective fluid line, and a second, collapsed state, set up to end the fluidic connection within the respective fluid line.

12. The valve switching cassette according to claim 1, wherein the valve switching cassette comprises at least one retainer frame covering one of the membrane structures at its flat side opposite the transfer plate, which retainer frame provides a detachable or non-detachable, fluid tight connection between the membrane structure and the transfer plate.

13. The valve switching cassette according to claim 1, wherein the valve switching cassette comprises at least one channel plate covering the membrane structure, which channel plate comprises holes enabling the plungers to engage with the deformed membrane structure, which channel plate comprises a plurality of channels, that define the deformation of the membrane structure into channel like primary fluid lines and channel like secondary fluid lines.

14. The valve switching cassette according to claim 1, wherein the ports each comprise a common interface conduit at or within the transfer plate, which interface conduit extends from one of the narrow sides of the transfer plate to one of the fluid lines.

15. The valve switching cassette according to claim 1, wherein the valve switching cassette comprises at least one cassette enclosure, which is assigned to one of the membrane structures and which defines a sealed interior between the cassette enclosure and the membrane structure.

16. A valve switching system with a valve switching cassette according to claim 1, wherein the valve switching system comprises an actuator block assigned to the valve switching cassette, wherein the actuator block acts on the membrane structure of the valve switching cassette for it to selectively engage the respective valve seat.

17. A bioprocess installation, comprising a valve switching system according to claim 16 and a component to be selectively interconnected by the valve switching cassette of the valve switching system.

18. The bioprocess installation according to claim 17, wherein, as a component to be selectively interconnected, the bioprocess installation comprises a chromatography arrangement with multiple chromatography columns, that are connected to the valve switching cassette of the valve switching system for performing a simulated moving bed chromatography process.

19. A method for operating a valve switching system according to claim 16, wherein valve membranes are provided by the membrane structure, which are selectively engaged as to switch the valve units.

20. The valve switching cassette according to claim 5, wherein a relative movement of the valve membranes mediates the opening or closing of the valve units.
